(19) United States
(12) Patent Application Publication
(10) Pub. No.: US 2004/0007344 A1
(43) Pub. Date: Jan. 15, 2004

(54) Method for manufacturing a crankshaft supporter

(76) Inventor: Makoto Nakamura, Shizuoka-ken (JP)

Correspondence Address: FLYNN THIEL BOUTELL & TANIS, P.C., 2026 RAMBLING ROAD, KALAMAZOO, MI, 49008-1699, US

(21) Appl. No.: 10/601,780

(22) Filed: Jun. 23, 2003

(30) Foreign Application Priority Data
Jun. 27, 2002 (JP) 2002-187756

(51) Int. Cl. B22D 19/08; B23P 17/00

(52) U.S. Cl. 164/98; 29/888.08; 164/340; 164/332

(57) ABSTRACT

A method for manufacturing a crankshaft supporter having a bearing holding section that holds a bearing for supporting a crankshaft, and that is cast in aluminum alloy with a preform cast inside, the preform having a through hole extending therethrough. Provided are a core pin to process the through hole, and a pin hole shaped in the preform to accommodate the core pin. The core pin includes a pin insert section having an outer diameter less than inner diameter of the preform pin hole, and a head section having an outer diameter greater than the inner diameter of the preform pin hole. The pin hole insert section is inserted into the pin hole to contact the head section with an outer surface of the preform for securement inside a mold for casting. The core pin is removed during subsequent cutting of a larger diameter hole through the cast bearing holding section.

### FIELD OF THE INVENTION

This invention relates to a method for manufacturing crankshaft supporters, and more particularly to a method of casting a crankshaft supporter that has a preform cast in a bearing holding section and which prevents movement of the preform by using core pins.

### BACKGROUND OF THE INVENTION

Some vehicles are provided with an internal combustion engine having a cylinder head mounted on a cylinder block defining one or more cylinders, a lower crankcase below the cylinder block to support a crankshaft in cooperation with the cylinder block, the lower crankcase having a crankshaft supporter with a bearing holder inside, and an oil pan attached to a bottom of the lower crankcase.

One example of manufacturing method for the crankshaft supporter is disclosed in JP Laid-Open No. H06-142834. According to the manufacturing method disclosed therein, supporting recesses are formed in both inner sides of a core for a water jacket. First core pins support both sides and top sides of the recesses, and second core pins support outer sides and top sides of the cores. The core is stably positioned in a cavity to prevent inward or outward deformation of the core by pressure of the molten metal.

Another example is shown in JP Laid-Open 2000-337348. A bearing for a crankshaft as disclosed therein includes a bearing construction to support the crankshaft in an internal combustion engine, and a holding section to hold the bearing construction. The bearing construction is formed of porous material. Material of the holding section flows into pores in the bearing construction. The bearing for the crankshaft comprises more than one member of different materials, thereby improving strength by the combination between the members.

Still another example is disclosed in JP Laid-Open 2002-61538. A cylinder block and method for manufacturing same disclosed therein includes a main body of the cylinder block, a bearing mounted to a bottom of the main body, a crankshaft rotatably supported by a bearing section defined by a bottom of the main body and the bearing, an aluminum alloy layer in a sliding section of the bearing section, and a composite material around the aluminum alloy layer. The composite material of the cylinder block has a thermal expansion coefficient lower than that of the aluminum alloy layer on the sliding section, which reduces not only vibration of the engine and noise of high temperature but also weight of the cylinder block.

In a conventional method for manufacturing the crankshaft supporter, when the cylinder block and the lower crankcase are cast in aluminum alloy for weight reduction whereas the crankshaft is cast in iron, a fiber-reinforced material (FRM) is employed as a preform in order to build a bearing construction that reduces expansion of an oil clearance resulting from thermal expansion of the bearing holding section that holds the bearing for the crankshaft. The FRM is formed by firing alumina fiber and penetrating it with cast aluminum alloy to form the crankshaft supporter. With this construction, the expansion of the oil clearance is prevented and the noise can be reduced since the FRM has a lower thermal expansion coefficient than that of the aluminum alloy.

When the FRM is employed as the bearing holding section of the lower crankcase, the preform is placed into metal molds and is cast in aluminum alloy. Referring to FIG. 5, upper and lower molds 124, 126 are disposed between right and left molds 122, 120, and the FRM preform 114 is placed in a space defined by the molds 120, 122, 124, 126. Tapered upper and lower core pins 128, 130 are inserted into a pin hole 116 in the preform 114 from above and below, and the preform 114 is placed in the molds 120, 122, 124, 126 and is cast.

Since the preform 114 is so rigid that it is hard to cut so as to subsequently form through holes 118 in the preform 114, a pin hole 116 is initially formed in the preform 114 during forming thereof, which pin hole 116 has a smaller diameter than the through hole 118 so as to narrow or reduce the material portion which is to be cut and removed. After casting with the core pins 128, 130 inserted into the pin hole 116, the through hole 118 is cut and shaped by drilling. The core pins 128, 130 are inserted so that a clearance space “s” is defined in the pin hole 116 due to variations in the size of the pin holes.

As a result, as indicated by an arrow in FIG. 5, the flow of the molten matal during casting undesirably moves the preform 114 within the mold cavity, which undesirably displaces the location of the preform within the cast crankshaft supporter.

In addition, this displacement may cause the preform to be broken by the impact of the molten metal, or may cause the rigid FRM of bad workability to be exposed at the surface of the crankshaft supporter.

In order to obviate or minimize the above-mentioned inconveniences, the present invention provides a method for manufacturing a crankshaft supporter having a bearing holding section that holds a bearing for supporting a crankshaft and that is cast in aluminum alloy with a preform cast inside, and a through hole penetrating into the preform of the bearing holding section and extending outwardly thereof. Provided are a core pin to process the through hole, and a pin hole shaped in the preform to accommodate the core pin. The core pin includes a pin insert section having an outer diameter less than an inner diameter of the preform pin hole, and a locking or head section having an outer diameter greater than the inner diameter of the preform pin hole. The pin hole insert section is inserted into the preform pin hole to contact the head section with an outer surface of the preform, with the head section being positioned for securement inside the mold to securely position the preform for casting of the crankshaft supporter therearound.

According to the present invention, in casting, the pin insert section is inserted into the preform pin hole while contacting the head section with the outer surface of the preform so as to be fixed in the mold, followed by casting. The core pin therefore prevents displacement of the preform during casting.

### BRIEF DESCRIPTION OF THE DRAWINGS

FIG. 1 is a schematic view illustrating a core pin inserted during casting according to an embodiment of the present invention.

FIG. 2 is a schematic block diagram showing part of an engine according to the present invention.

FIG. 3 is an enlarged schematic perspective view illustrating another embodiment of the present invention.

FIG. 4 is a partial enlarged view of metal molds, preform, and core pins according to a further embodiment of the invention.

FIG. 5 is a schematic view illustrating a core pin inserted during casting according to the prior art.

### DETAILED DESCRIPTION

The present invention will now be described in specific detail with reference to the Figures.

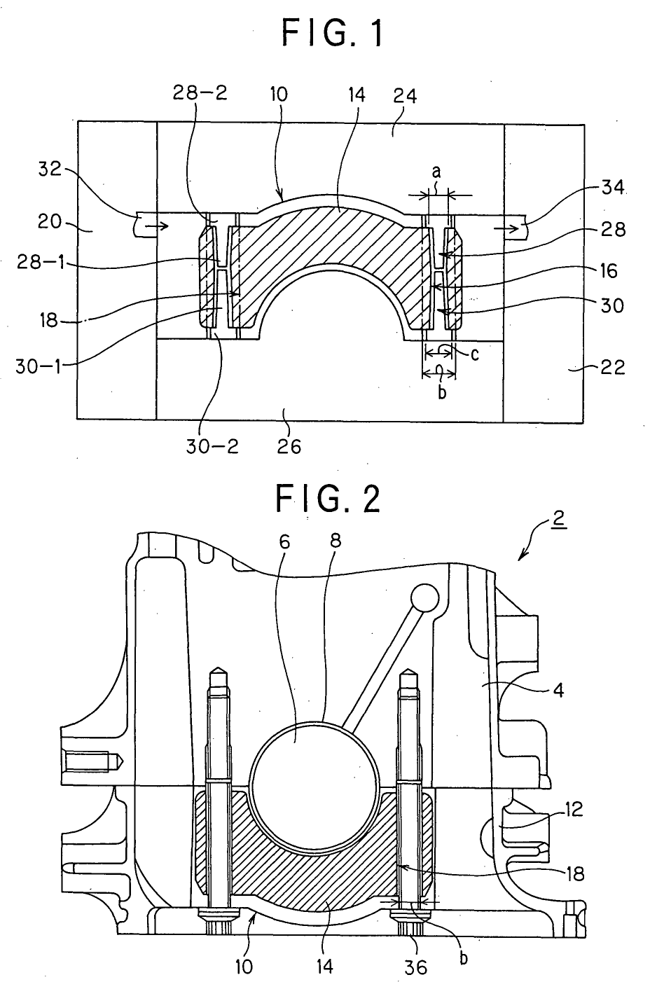

FIGS. 1 and 2 illustrate an embodiment of the present invention. FIG. 2 shows part of an engine 2, and a cylinder block 4.

In the engine 2, a cylinder head (not shown) is mounted on top of the cylinder block 4 having cylinders (not shown) inside. Below the cylinder block 4, a crankcase 12 has a crankshaft supporter which includes a bearing holding section 10 supporting thereon a bearing 8 for a crankshaft 6 which is disposed between the cylinder block 4 and the crankcase. An oil pan (not shown) is attached to a bottom of the crankcase 12.

The bearing holding section 10 is preferably cast of aluminum alloy and has a preform 14 cast inside. The preform 14 is typically constructed of fired alumina fiber.

In the bearing holding section 10, a pin hole 16 having inner diameter “a” extends outwardly through the preform 14 and accommodates core pins, i.e., upper and lower core pins 28, 30 (mentioned later). After casting, it is required to shape the bearing section 10 including the preform 14 by cutting, so that a through hole 18 that extends outwardly through the section 10 and the preform 14 has an inner diameter “b” greater than the diameter “a” of the pin hole 16. Hole 18 is indicated by a “double dotted and dashed line” in FIG. 1.

To cast the bearing holding section 10, a first left metal mold 20 and a second right mold 22 are provided, and a third upper mold 24 and a fourth lower mold 26 are provided therebetween. By using the upper core pin 28 engaged with the upper mold 24 and the lower core pin 30 engaged with the lower mold 26, the preform 14 is placed in the cavity defined by the molds 20, 22, 24, 26. Although other metal molds are required to be disposed on the molds 20, 22, 24, 26 in FIG. 1, the explanation of these other molds is omitted.

The upper and lower core pins 28, 30 include pin insert sections 28-1, 30-1 having outer diameters less than inner diameter “a” of the preform pin hole 16, and locking or head sections 28-2, 30-2 having outer diameters “c” greater than inner diameter “a” of the preform pin hole 16.

The pin insert sections 28-1, 30-1 are preferably tapered, i.e., gradually decreased in diameter away from the molds 24, 26 respectively. The locking sections 28-2, 30-2 have outer diameter “c” less than inner diameter “b” of the through hole 18 which is subsequently formed in the bearing supporter 10 in alignment with the preform hole 16.

As shown in FIG. 1, the upper and lower core pins 28, 30 are opposingly inserted into the preform pin hole 16 from both ends thereof, i.e., from above and below respectively.

Reference numeral 32 designates an inlet to supply melted aluminum alloy, and 34 an outlet to discharge excessive aluminum alloy.

As shown in FIG. 2, fixing bolts 36 extend through the through holes 18 to secure the bearing supporters 10 and the lower crankcase 12 to the cylinder block 4.

Operation of this embodiment is described below.

Firstly, in the casting process, the pin insert sections 28-1, 30-1 of the upper and lower core pins 28, 30 are inserted into the preform pin hole 16 from the opposite ends thereof, i.e., from above and below respectively.

The preform 14 is then fixed in the mold cavity defined by the molds 20, 22, 24, 26 by contacting the outer surfaces of the head sections 28-2, 30-2 with the opposed surfaces on the respective upper and lower molds 24, 26.

After the preform 14 is fixed in the closed mold, the melted aluminum alloy is supplied from the inlet 32 into the mold space around the preform 14, i.e., the cavity defined by the molds 20, 22, 24, 26, to cast the preform within the bearing holding section 10. At this time, the pin holes 16 in the preform 14 are closed at both ends by the locking sections 28-2, 30-2 of the upper and lower core pins 28, 30 contacting the surfaces of the preform 14. However, the molten metal penetrates into the pin hole 16 through spaces (not shown) in the preform 14 due to its fibrous construction.

After casting and removal of the cast part from the mold, the through hole 18 is formed by cutting generally along the axis of the preform hole 16 so that the through hole 18 extends outwardly through the bearing section 10 and has an inner diameter “b” greater than the diameter of the locking sections 28-2, 30-2. After cutting of hole 18, no trace of the locking sections 28-2, 30-2 of the upper and lower core pins 28, 30 are left on an outer surface of the preform, and in fact the entirety of the locking sections 28-2, 30-2 as well as the pin sections 28-1, 30-1 are removed.

As thus described, the upper and lower core pins 28, 30 are provided with the pin insert sections 28-1, 30-1 having an outer diameter less than an inner diameter “a” of the pin hole 16 in preform 14, and with the locking or head sections 28-2, 30-2 having an outer diameter “c” greater than the inner diameter “a” of the preform pin hole 16. The pin insert sections 28-1, 30-1 are inserted into the pin hole 16 of the preform while the outer surface of preform 14 contacts the locking sections 28-2, 30-2 so as to fix the preform 14 in the molds 20, 22, 24, 26. During casting, the upper and lower core pins 28, 30 and their engagement between the preform and the mold prevent displacement of the preform 14, which is advantageous from a practical point of view.

Also, the upper and lower core pins 28, 30 including the locking sections 28-2, 30-2 have outer diameter “c” smaller than inner diameter “b” of the through hole 18 that is shaped by cutting after casting. Thereby, when cutting the through hole 18, core portions corresponding to outer diameter “c” of the locking sections 28-2, 30-2 can be quickly removed, which permits an easier cutting process.

Further, the upper and lower core pins 28, 30 are inserted into the preform pin hole 16 opposingly from both ends of the pin hole, i.e., from above and below respectively, so that the locking sections 28-2, 30-2 bindingly secure the preform 14 in the mold to prevent displacement of the preform 14.

The present invention is not limited to the above-mentioned embodiment, but is adaptable for various applications and variations or modifications.

According to the above-mentioned embodiment, the explanation is given as to the bearing holding section that supports the crankshaft bearing. Instead of the crankshaft, it is applicable to the bearing holding sections for, e.g., a camshaft or a transmission axle.

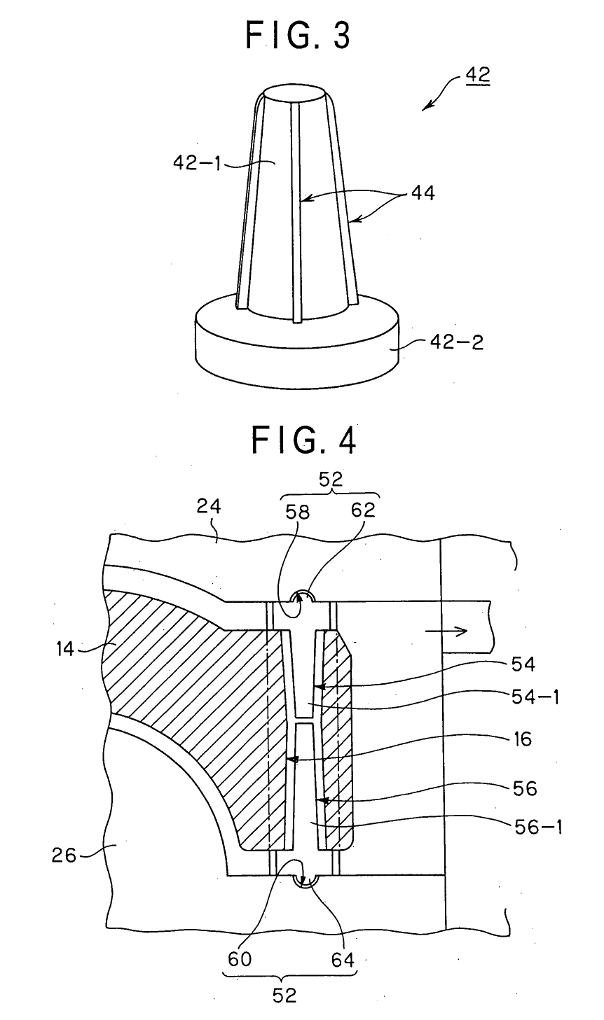

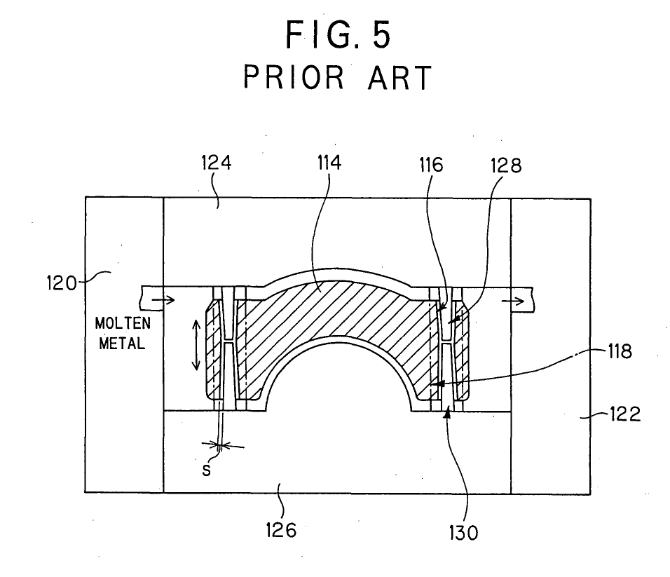

In addition, the embodiment is configured to provide the upper and lower core pins 28, 30 with the pin insert sectinos 28-1, 30-1 having outer diameter smaller than the inner diameter “a” of the preform pin hole 16, and with the stepped locking or head sections 28-2, 30-2 having outer diameter “c” greater than the inner diameter “a” of the pin hole 16. However, a core pin 42 (FIG. 3) may be provided with a protrusion 44 to prevent sideward displacement of the preform.

More particularly, as shown in FIG. 3, the core pin 42 may be provided with a pin insert section 42-1 having outer diameter smaller than inner diameter of the preform pin hole, and a locking section 42-2 having outer diameter greater than the inner diameter of the preform pin hole. On the outer circumference of the pin insert section 42-1, a plurality, e.g. four, of protrusions 44 is formed and spaced uniformly. The protrusions 44 in the illustrated emobdiment are defined as outwardly protruding ribs which are elongated along the length of the pin insert section.

The outer diameter of the protrusion 44 is smaller than the inner diameter of the preform pin hole at a top or free end of the pin insert section 42-1, but is the same as the inner diameter of the preform pin hole toward a base of the pin insert section 42-1, i.e., where it joins the locking section 42-2.

Accordingly, when the pin insert section 42-1 of the core pin 42 is inserted into the preform pin hole, the protrusions 44 contact with an inner surface of the pin hole to accommodate the pin insert section 42-1 of the core pin 42 within the pin hole. This prevents sideward displacement of the preform relative to the core pin. Also, it is easy to remove the core pin 42 after casting, since contact between the pin hole and the protrusion 44 is narrow.

As another special configuration, a positioning means 52 (FIG. 4) can be provided to locate the preform 14 as placing it in the upper, lower, right, and left molds. More particularly, the concave positioning means 52 permits upper and lower convex core pins 54, 56 to be fixedly positioned to the upper and lower molds 24, 26.

Referring to FIG. 4, a first recess 58, for example, is formed in the upper third mold 24, and a second recess 60 is formed in the lower fourth mold 26. A first convex protrusion 62 is formed on the upper core pin 54 for insertion into the first recess 58, and a second convex protrusion 64 is formed on the lower core pin 56 for insertion into the second recess 60. The protrusions 62, 64 project outwardly from the flat outer end surface of the respective head section of the core pin.

Incidentally, the first and second recesses 58, 60 are preferably formed in an elongate groove shape that extends from front to back in FIG. 4, and the first and second convex protrusions 62, 64 are elongate from front to back in FIG. 4.

For positioning the preform 14 in the molds, the pin insert sections 54-1, 56-1 of the upper and lower core pins 54, 56 are first inserted into the pin hole 16 in the preform 14. Then the preform 14 is positioned within the molds while the first convex protrusion 62 of the upper core pin 54 is fit into the first recess 58 of the upper third mold 24, and the second convex protrusion 64 of the lower core pin 56 is fit into the second recess 60 of the lower fourth mold 26. The elongate recess 58, 60 permits adjustment of the vertical and horizontal position of the preform 14.

As thus described, the present invention provides a method for manufacturing a crankshaft supporter having a bearing holding section that holds a bearing for supporting a crankshaft, and that is cast in aluminum alloy with a preform cast inside, which preform has a through hole penetrating therethrough. Provided are a core pin to process the through hole and a pin hole shaped in the preform to accommodate the core pin. The core pin includes a pin insert section having an outer diameter less than the inner diameter of the preform pin hole, and a locking or head section having an outer diameter greater than the inner diameter of the preform pin hole. The pin hole insert section is inserted into the preform pin hole to contact the locking section with an outer surface of the preform for securement inside a mold for casting. The core pin prevents displacement of the preform during casting.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A method for manufacturing a crankshaft supporter having a bearing section to hold a bearing for supporting a crankshaft, said bearing section being cast in aluminum alloy and having a preform cast inside, comprising steps of:
providing a core pin;
providing a preform having a pin hole therein to accommodate said core pin;
providing said core pin with (1) a pin insert section having an outer diameter less than an inner diameter of said pin hole and (2) a head section having an outer diameter greater than said inner diameter of said pin hole;
fixing said preform in a mold with said pin insert section inserted into said pin hole and said head section in contact engagement between an outer surface of said preform and a surface of said mold;
casting said bearing section around said preform and said head section of said core pin; and
forming a through hole in the bearing section which penetrates the preform along the pin hole.

2. The method for manufacturing the crankshaft supporter as defined in claim 1, wherein said core pin includes said head section having said outer diameter less than an inner diameter of said through hole.

3. The method for manufacturing the crankshaft supporter as defined in claim 1, wherein a pair of said bore pins are opposingly inserted into said pin hole from opposite ends thereof;

4. The method for manufacturing the crankshaft supporter as defined in claim 1, including providing the opposed contacting surfaces on the mold and head section with an interfitting protrusion and recess to positionally restrain the preform relative to the mold.

5. The method for manufacturing the crankshaft supporter as defined in claim 1, including providing the pin insert section of the core pin with outwardly protruding ribs at least in the vicinity of said head section so that said ribs contact an inner surface of the pin hole to prevent sideward displacement of the core pin relative to the preform when the pin insert section is inserted into the pin hole.

6. The method for manufacturing the crankshaft supporter as defined in claim 1, including providing the preform with a center portion having a concave recess formed therein for accommodating a crankshaft bearing, providing the preform with a pair of side sections disposed on opposite sides of the center section with each said side section having a said pin hole extending therethrough, and inserting a pair of said core pins into each said pin hole from opposite ends thereof for positionally supporting the preform within a mold cavity defined by the mold.

7. The method for manufacturing the crankshaft supporter as defined in claim 6, including constructing the preform of alumina fiber which is penetrated by the aluminum alloy during casting.

8. The method of manufacturing the crankshaft supporter as defined in claim 1, including forming the through hole by cutting a hole of diameter greater than the outer diameter of the core pin head section through the bearing section in alignment with the pin hole so as to effect removal of the entirety of the core pin.

9. A method for manufacturing a crankshaft supporter which attaches to a cylinder head of a vehicle engine to rotatably support a crankshaft therebetween, comprising the steps of:
providing a preform having a center bearing section connected between a pair of side sections each having a pin hole extending therethrough;
providing a mold having a mold cavity corresponding to the shape of the crankshaft supporter;
providing a plurality of core pins each having a pin insert section which is sized to be insertable into one of said pin holes and an enlarged head section which has a cross section greater than the cross section of the pin hole so that the head section is adapted to abut a peripheral surface of the preform;
inserting at least one core pin into each said pin hole so that the head section of each core pin abuts a peripheral surface of the preform adjacent an open end of the pin hole;
positioning the preform and the core pins inserted therein within the mold cavity so that the head sections of the core pins engage a boundary wall defining the mold cavity so as to stationarily support the preform within the mold cavity in defined spaced relationship from the boundary wall;
supplying molten metal into the mold cavity to surround the preform and define the crankshaft supporter;
removing the molded crankshaft supporter, with the preform embedded therein, from the mold cavity; and then
forming a through hole through the crankshaft supporter generally in alignment with the pin hole.

10. The method as defined in claim 9, wherein the forming of the through hole in the crankshaft supporter comprises cutting a hole of cross section which is greater than the cross section of the pin hole so as to effect removal of the core pin during forming of the through hole.

11. The method as defined in claim 9, wherein forming of the through hole comprises cutting of a hole having a cross section equal to or greater than the cross section of the core pin head section so as to effect removal of the entirety of the core pin during forming of the through hole.

12. A method as defined in claim 9, including inserting a pair of said core pins into each said pin hole from opposite ends thereof so that the head sections associated with the pair of core pins inserted into each pin hole are positioned for engagement with opposed surfaces defining the boundary wall so as to stationarily and securely position the preform within the mold cavity in defined spaced relationship from the surrounding boundary wall.

13. A method as defined in claim 9, including providing the pin insertion section of the mold pin with outward protrusions which are sized to engage the wall defining the pin hole to prevent sideward movement of the preform relative to the core pin.

14. A method as defined in claim 9, including providing the head section of the core pin with a protrusion which engages within a recess formed in an opposed boundary wall to stationarily hold the mold pin and the engaged preform within the mold cavity.
